(19) United States
(12) Patent Application Publication
(10) Pub. No.: US 2024/0240108 A1
(43) Pub. Date: Jul. 18, 2024

(54) OPTIMIZED PROCESS FOR THE HYDROTREATING AND HYDROCONVERSION OF FEEDSTOCKS DERIVED FROM RENEWABLE SOURCES

(71) Applicant: IFP Energies nouvelles, RUEIL-MALMAISON (FR)

(72) Inventors: Christophe BOUCHY, RUEIL-MALMAISON CEDEX (FR); Anne-Sophie GAY, RUEIL-MALMAISON CEDEX (FR); Mélanie GOMEZ ALMENDROS, RUEIL-MALMAISON CEDEX (FR)

(73) Assignee: IFP Energies nouvelles, RUEIL-MALMAISON (FR)

(21) Appl. No.: 18/558,622

(22) PCT Filed: Apr. 15, 2022
(86) PCT No.: PCT/EP2022/060159

§ 371 Date: Nov. 2, 2023

(30) Foreign Application Priority Data
May 4, 2021 (FR) 2104684

(51) Int. Cl. C11C 3/12; B01D 3/14; B01J 21/12; B01J 23/888; B01J 37/02; B01J 37/08; B01J 37/20

(52) U.S. Cl. CPC C11C 3/126; B01D 3/14; B01J 21/12; B01J 23/888; B01J 37/0201; B01J 37/08; B01J 37/20; C11C 3/123

(57) ABSTRACT

The present invention describes a process for treating a feedstock obtained from a renewable source, comprising a step a) of hydrotreating said feedstock, a step b) of separation into at least a light fraction and at least a hydrocarbon liquid effluent, a step c) of removing at least a portion of the water from the hydrocarbon liquid effluent, a step d) of hydroconversion of at least a portion of the hydrocarbon liquid effluent, said hydroconversion step d) being characterized firstly by the use of a bifunctional catalyst comprising a molybdenum and/or tungsten sulfide phase promoted with nickel and/or cobalt and secondly by a ratio between the partial pressure of hydrogen sulfide and of hydrogen at the inlet of the hydroconversion unit of 10 less than 5×10⁻⁵ and a step e) of fractionation of the effluent obtained from step d) to obtain at least a middle distillate fraction.

### FIELD OF THE INVENTION

The search for new renewable energy sources for the production of fuels is a major challenge both for meeting fuel demand and for addressing environmental concerns.

In this respect, the economic exploitation as fuels of feedstocks derived from renewable sources has received substantial renewed interest in recent years. Among these feedstocks, examples that may be mentioned include plant oils, animal fats, which are raw or which have undergone a pretreatment, and also mixtures of such feedstocks. These feedstocks contain chemical structures of triglyceride or fatty acid or ester type, the structure and length of the hydrocarbon chain of these feedstocks being compatible with the hydrocarbons present in gas oils and kerosene.

One possible route is catalytic transformation of the feedstock obtained from a renewable source into paraffinic fuel deoxygenated in the presence of hydrogen (hydrotreating). Many metal catalysts or sulfides are known to be active for this type of reaction.

These processes for the hydrotreating of feedstocks derived from renewable sources are already well known and are described in numerous patents. Mention may be made, for example, of the following patents: U.S. Pat. Nos. 4,992,605, 5,705,722, EP 1 681 337 and EP 1 741 768.

The use of solids based on transition metal sulfides allows the production of paraffins from molecules of ester type according to two reaction pathways:
hydro-deoxygenation leading to the formation of water by consumption of hydrogen and to the formation of hydrocarbons with a carbon number (Cₙ) equal to that of the initial fatty acid chains,
decarboxylation/decarbonylation leading to the formation of carbon oxides (carbon monoxide and dioxide: CO and CO₂) and to the formation of hydrocarbons containing one carbon less (Cₙ₋₁) relative to the initial fatty acid chains.

The liquid effluent obtained from these hydrotreating processes, after separation, consists essentially of n-paraffins and is substantially free of sulfur-based, nitrogen-based and oxygen-based impurities. After hydrotreating and separation of the gases, the sulfur content is typically between 1 and 20 ppm by weight, the nitrogen content is generally between 0.2 and 30 ppm by weight and the oxygen content is generally less than 2000 ppm by weight. The paraffins have a number of carbon atoms typically between 9 and 25, which is mainly dependent on the composition of the feedstock to be hydrotreated.

However, this liquid effluent generally cannot be incorporated as such into the kerosene or gas oil pool notably on account of insufficient cold properties and/or excessively high boiling points. Specifically, the paraffins present lead to high pour points and thus to setting phenomena for uses at low temperatures. For example, eicosane (linear paraffin of 20 carbon atoms, C₂₀H₄₂) has a boiling point equal to 340° C. and a melting point of 37° C. The boiling point of eicosane is thus compatible with its incorporation in a gas oil pool but its melting point may give rise to setting problems and limit its use. By way of illustration, the limit filterability temperature for a winter gas oil is a maximum of −15° C. Moreover, the boiling point of eicosane renders it ineligible for incorporation into a kerosene pool, for which the final temperature of the distillation curve must be less than 300° C.

Depending on the degree of incorporation and the favored fuel pool (gas oil or kerosene) targeted, it may be necessary to perform a hydroconversion step (hydroisomerization and/or hydrocracking reactions) to transform the linear paraffins of the hydrotreated liquid effluent. Hydroisomerization makes it possible to convert a linear paraffin into a branched paraffin with conservation of the number of carbon atoms of the molecule. This makes it possible to improve the cold properties of the effluent since branched paraffins have better cold properties than linear paraffins. For example, nonadecane has a melting point of 32° C., whereas one of its singly branched isomers, 7-methyloctadecane, has a melting point of −16° C. Hydrocracking enables a linear paraffin to be converted into linear or branched paraffins of smaller molecular weight. This makes it possible to adjust, as need be, the distillation curve of the effluent to render it compatible with the kerosene pool. By way of illustration, the hydrocracking of an eicosane molecule can lead to the production of two 2-methylnonane molecules. The boiling point of 2-methylnonane is 167° C., which is compatible with incorporation into the kerosene pool. The hydroconversion step is performed on a bifunctional catalyst containing both a hydro/dehydrogenating function and a Brønsted acid function. The operating conditions may be adapted to promote the hydroisomerization or hydrocracking reactions as need be. In any case, it is desirable to minimize the production of cracking products that are too light to be incorporated into the kerosene or gas oil pool.

The appropriate choice of the acidic phase makes it possible to promote the isomerization of long linear paraffins and to minimize the cracking. Thus, the form selectivity of medium-pore (10 MR) one-dimensional zeolites such as zeolites ZSM-22, ZSM-23, NU-10, ZSM-48 and ZBM-30 makes them particularly suitable for use for obtaining catalysts that are selective toward isomerization. Other acidic phases of zeolite or non-zeolite type such as halogenated (notably chlorinated or fluorinated) aluminas, phosphorus-based aluminas, silica-aluminas or siliceous aluminas may also be used.

However, it is well known that factors other than the acidic phase have an impact on the activity and selectivity of a bifunctional catalyst. Hydroisomerization and hydrocracking of normal paraffins have thus been the subject of numerous academic studies since the original investigations in the 1960s by Weisz or Coonradt and Garwood. The most commonly accepted mechanism first involves dehydrogenation of the n-paraffin to an n-olefin on the hydro-dehydrogenating phase and then, after diffusion to the acidic phase, protonation to a carbenium ion. After structural rearrangement and/or β-cleavage, the carbenium ions are desorbed from the acidic phase in the form of olefins after deprotonation. Next, after diffusion to the hydro-dehydrogenating phase, the olefins are hydrogenated to form the final reaction products. It is then appropriate to have a hydro/dehydrogenating function that is sufficiently active toward the acid function firstly to rapidly supply the acidic phase with olefins and secondly to rapidly hydrogenate the olefinic intermediates after they have reacted on the acidic phase. This makes it possible firstly to maximize the activity of the catalyst and secondly to promote hydroisomerization relative to hydrocracking when the first reaction is desired, or to limit the production of excessively light cracking products when the hydrocracking reaction is desired. The use of a sufficiently active hydrogenating function is also desirable so as to limit the deactivation of the bifunctional catalyst by coking during the hydroconversion of n-paraffins (Alvarez et al., Journal of Catalysis, 162, 2, 179-189) for a range of set operating conditions.

Noble metals (Pt, Pd) or transition metals from group VIA (Mo, W) combined with transition metals from group VIII (Ni, Co) can act as hydrogenating function for the catalyst. The noble metals are used in their reduced form whereas the transition metals are used in a sulfurized form. For the latter, there is a known synergistic effect between the transition metals of group VIA and the transition metals of group VIII, generally attributed to the decoration of the sulfide phases of group VIA with the transition metals of group VIII. This is then referred to as a molybdenum or tungsten sulfide phase promoted with nickel or cobalt (“CoMoS”, “NiMOS”, “NiWS”). This synergistic effect is reflected by an increase in the catalytic activity of the promoted phase in comparison with an unpromoted phase.

The choice of the nature of the hydrogenating function, of noble metal or sulfide type, depends on various criteria, of economic nature (the price of noble metals is markedly higher than that of transition metals of groups VIA and VIII) or of chemical nature (impact of the presence of contaminants). Thus, the hydrogenating activity of noble metals is higher than that of transition metal sulfides when the partial pressure of hydrogen sulfide (H₂S) in the reaction medium is low or even zero. Conversely, the hydrogenating activity of transition metal sulfides is higher than that of noble metals when the partial pressure of H₂S in the reaction medium becomes high (C. Marcilly, Catalyse acido-basique [Acid-base catalysis], volume 2, 2003, published by Technip). Moreover, it is reported that the use of transition metal sulfides requires the presence of H₂S in the reaction medium to ensure their stability, and notably maintenance of the promotion of the molybdenum or tungsten sulfide phases with nickel or cobalt under reaction conditions. Maintenance of promotion is desirable in order to conserve the synergistic effect and to have maximum activity of the sulfide phase. For example, as a test molecule for the hydrogenation of toluene, a catalyst based on a tungsten sulfide phase promoted with nickel (“NiWS”) on silica-alumina has an activity per tungsten atom that is 16 times greater than that of a catalyst based on tungsten sulfide that is not promoted with nickel (“WS”) on silica-alumina (M. Girleanu et al., ChemCatChem 2014, 6, 1594-1598). Maintenance of promotion depends on the operating conditions under which the catalyst works. Studies combining molecular modeling by DFT and a thermodynamic model thus make it possible to propose stability diagrams for the promoted phases as a function of a thermodynamic magnitude known as the sulfur chemical potential. The sulfur chemical potential value is itself calculated from the temperature of the medium and from the ratio between the partial pressures of hydrogen sulfide (H₂S) and of hydrogen (H₂) and is available in graph form (C. Arrouvel et al., Journal of Catalysis 2005, 232, 161-178). The sulfur chemical potential decreases when the temperature increases, and when the ratio between the partial pressures of hydrogen sulfide and of hydrogen decreases. It is thus possible to evaluate the thermodynamic stability of the promoted phases as a function of the operating conditions. Thus, it is reported that the NiWS phase is no longer thermodynamically stable (complete segregation of the nickel and loss of promotion) for sulfur chemical potential values of less than −1.27 eV.

In the field of the hydroconversion of long paraffins (waxes), obtained from Fischer-Tropsch synthesis, on sulfide bifunctional catalysts of NiMOS or NiWS type on silica-alumina, D. Leckel (Energy & Fuels 2009, 23, 5-6, 2370-2375) reports that the H₂S content in the gas at the unit outlet must be at least 100 ppm and preferably at least 200 ppm to keep the catalyst in its sulfurized form. The composition of the outlet gas is not specified. The values provided correspond to P(H₂S)/P(H₂) ratios that are at least greater than 1×10⁻⁴ and preferably at least greater than 2×10⁻⁴ in the case where it is assumed that the outlet gas consists only of H₂S and hydrogen.

Patent application FR2940144 A1 claims a process for the hydro-deoxygenation of feedstocks obtained from renewable sources. The effluent obtained from the hydro-deoxygenation is subjected to a separation step and preferably to a step of gas/liquid separation and of separation of water and of at least one liquid hydrocarbon base. After a step of removing the nitrogen-based compounds, said liquid hydrocarbon base is hydroisomerized on a bifunctional hydroisomerization catalyst. It is taught that it is possible to add a certain amount of sulfur-based compounds, for instance dimethyl disulfide, to keep the catalyst in its sulfurized form, if need be. Advantageously, the amount of sulfur is such that the content of H₂S in the recycle gas that is sent into the hydroisomerization step is at least 15 ppm by volume, preferably at least 0.1% by volume and preferably at least 0.2% by volume. The composition of the recycle gas is not specified. The values provided correspond to P(H₂S)/P(H₂) ratios that are at least greater than 1.5×10⁻⁵ and preferably at least greater than 1×10⁻³ and preferably greater than 2×103 in the case where it is assumed that the recycle gas consists only of H₂S and hydrogen. No examples are provided.

Patent application WO 2009/156452 A1 (SHELL) claims a process for producing paraffinic hydrocarbons from a feedstock containing triglycerides, diglycerides, monoglycerides and/or fatty acids. Said process comprises (a) a hydro-deoxygenation step in the presence of hydrogen and of a catalyst so as to obtain an effluent comprising water and paraffins, (b) a step of separating the effluent obtained from (a) to obtain a paraffin-rich liquid effluent and (c) a step of hydroisomerization of said paraffin-rich effluent in the presence of hydrogen and of a catalyst comprising nickel sulfide and tungsten and/or molybdenum sulfide as hydrogenating phases and a support comprising silica-alumina and/or a zeolite. It is taught that the use of sulfide phases instead of noble metals as hydrogenating phases removes the need to completely eliminate the impurities from the effluent obtained from step (a). It is also taught that to keep the hydroisomerization catalyst in its sulfurized form, it is necessary to supplement the makeup hydrogen with hydrogen sulfide (H₂S) or a hydrogen sulfide precursor such as dimethyl disulfide. No minimum hydrogen sulfide content is taught. Step (c) of the example given uses a hydroisomerization catalyst of NiWS/silica-alumina type. In order to keep the catalyst in its sulfurized form, 5000 ppm of sulfur are added to the feedstock in the hydroisomerization step in the form of di-tert-butyl polysulfide. This corresponds to a ratio between the partial pressure of H₂S and the partial pressure of hydrogen of 2.2×10⁻³ at the reactor inlet after decomposition of the di-tert-butyl polysulfide.

Patent application US 2011/0219669 A1 claims a method for producing diesel fuel, comprising the mixing of a feedstock of renewable origin and a fossil feedstock, said mixture then being transformed on contact of a deparaffinning/isomerization catalyst involving a hydrogenating function and a zeolite-type acid function. It is taught that when the hydrogenating function of said catalyst is of sulfurized type, for example NiWS, the hydrocarbon feedstock must contain a minimum of sulfur to keep the hydrogenating function in its sulfurized form. The recommended minimum sulfur content (present in sulfur-based molecules) in the feedstock is at least 50 ppm by weight, preferably at least 100 ppm by weight, preferably at least 200 ppm by weight. The decomposition of the these sulfur-based molecules in deparaffinning/isomerization reactor makes it possible to generate a partial pressure of H₂S necessary for keeping the hydrogenating phase in its sulfide form. Alternatively, the sulfur may be supplied directly in the form of H₂S, for example already present in the hydrogen-rich gas stream supplying the unit.

Specifically, the hydroconversion step may use hydrogen originating from various sources. Depending on the nature of the various sources, the hydrogen used in the process according to the invention may or may not contain impurities. For example, a catalytic reforming unit produces hydrogen during the reactions for the dehydrogenation of naphthenes to aromatic products and during the dehydrocyclization reactions. The hydrogen produced by a catalytic reforming unit is substantially free of CO and of CO₂. The hydrogen may also be produced via other methods, for instance by the steam reforming of light hydrocarbons or by the partial oxidation of various hydrocarbons such as heavy residues. Steam reforming consists in transforming a light hydrocarbon feedstock into synthesis gas, i.e. a mixture of hydrogen (H₂), carbon monoxide (CO), carbon dioxide (CO₂) and water (H₂O) by reaction with steam over a nickel-based catalyst. In this case, the production of hydrogen is also accompanied by the formation of carbon oxides that are substantially eliminated by the steam conversion of the carbon monoxide (CO) into carbon dioxide (CO₂) and then by elimination of the CO₂ by absorption, for example with an amine solution. There may also be elimination of the residual carbon monoxide (CO) via a methanation step. Other sources of hydrogen may also be employed, such as hydrogen obtained from catalytic cracking gases which contain significant amounts of CO and of CO₂. The hydrogen employed may also originate from the gas from the outlet of a hydrotreating unit; in this case, this hydrogen may undergo more or less rigorous purification steps to remove impurities such as ammonia (NH₃) or hydrogen sulfide (H₂S).

In an attempt to develop a process for treating feedstocks from renewable sources comprising at least one hydrotreating step and one hydroconversion step, characterized by the use of a bifunctional catalyst comprising a molybdenum and/or tungsten sulfide phase in combination with at least nickel and/or cobalt, the Applicant has discovered, surprisingly, that reducing the ratio between the partial pressure of hydrogen sulfide and the partial pressure of hydrogen entering the hydroconversion unit below the values usually disclosed in the prior art makes it possible to improve the performance of said hydroconversion catalyst.

One advantage of the process according to the present invention is thus that of providing a process for treating a feedstock obtained from a renewable source which undergoes hydrotreating before being sent into a hydroconversion step using a bifunctional catalyst comprising a molybdenum and/or tungsten sulfide phase promoted with nickel and/or cobalt, said catalyst operating under operating conditions such that the ratio between the partial pressure of H₂S and the partial pressure of hydrogen entering said hydroconversion step is less than 5×10⁻⁵.

One advantage of the present invention is that of providing a process for obtaining a gain in activity and selectivity of the hydroconversion catalyst. The use of the operating conditions in accordance with the invention makes it possible, all factors being otherwise equal, to reduce the temperature required to obtain a target cold property value for the middle distillate cut (measured, for example, by a cloud point value). The use of the operating conditions in accordance with the invention also makes it possible to increase the yield of middle distillate cut for a target cold property value (measured, for example, by a cloud point value).

In a preferred embodiment, one advantage of the process according to the invention is also that of enabling better resistance of the hydroconversion catalyst to deactivation when the operating conditions of the hydroconversion step, notably in terms of total pressure and of hydrogen-to-feedstock ratio, promote deactivation.

Another advantage of the process according to the invention is also to allow better resistance of the hydroconversion catalyst to the possible presence of oxygenated compounds.

Finally, in accordance with the invention, temporary functioning of the hydroconversion unit under operating conditions not in accordance with the invention is not excluded. It may thus occur that the ratio between the partial pressure of hydrogen sulfide and the partial pressure of hydrogen is not in accordance with the invention over certain periods, for example on account of sporadic poor functioning of tools that may be used for purifying the hydrogen sent into the hydroconversion unit and/or the liquid hydrocarbon effluent obtained from step c). In this case, the restoration of the tools that may be used for purifying the hydrogen and/or the hydrocarbon effluent obtained from c) makes it possible to regain an operating mode of the process in accordance with the invention.

### SUBJECT OF THE INVENTION

More precisely, the present invention relates to a process for treating a feedstock obtained from a renewable source, comprising at least:
a) a step of hydrotreating said feedstock in the presence of a catalyst in a fixed bed, said catalyst comprising a hydrogenating function and an oxide support, at a temperature of between 200 and 450° C., at a pressure of between 1 MPa and 10 MPa, at an hourly space velocity of between 0.1 h⁻¹ and 10 h⁻¹ and in the presence of a total amount of hydrogen mixed with the feedstock such that the hydrogen/feedstock ratio is between 70 and 1000 Nm³ of hydrogen/m³ of feedstock,
b) a step of separating at least a portion of the effluent obtained from step a) into at least a light fraction and at least a hydrocarbon liquid effluent,
c) a step of removing at least a portion of the water from the hydrocarbon liquid effluent obtained from step b), d) a step of hydroconversion of at least a portion of the hydrocarbon liquid effluent obtained from step c) in the presence of a bifunctional hydroconversion catalyst in a fixed bed, said catalyst comprising a molybdenum and/or tungsten sulfide phase in combination with at least nickel and/or cobalt, said hydroconversion step being performed at a temperature of between 250° C. and 500° C., at a pressure of between 1 MPa and 10 MPa, at an hourly space velocity of between 0.1 and 10 h⁻¹ and in the presence of a total amount of hydrogen mixed with the feedstock such that the hydrogen/feedstock ratio is between 70 and 1000 Nm³/m³ of feedstock, in the presence of a total amount of sulfur such that the ratio between the partial pressure of hydrogen sulfide and of hydrogen at the inlet of said hydroconversion step is less than 5×10⁻⁵, preferably less than 4×10⁻⁵, very preferably less than 3×10⁻⁵, very preferably less than 2×10⁻⁵ and even more preferably less than 1.5×10⁻⁵.
e) a step of fractionating the effluent obtained from step d) to obtain at least a middle distillate fraction.

### DETAILED DESCRIPTION OF THE INVENTION

### Feedstocks

The present invention is particularly dedicated to the preparation of gas oil and/or kerosene fuel bases which meet the new environmental standards, starting with feedstocks obtained from renewable sources.

The feedstocks obtained from renewable sources used in the process according to the present invention are advantageously chosen from oils and fats of plant or animal origin, or mixtures of such feedstocks, containing triglycerides and/or free fatty acids and/or esters. The plant oils may advantageously be crude or totally or partially refined, and may be derived from the following plants: rapeseed, sunflower, soybean, palm, palm kernel, olive, coconut, jatropha, this is not being limiting. Algal oils or fish oils are also relevant. The animal fats are advantageously chosen from lard or fats composed of residues from the food industry or derived from the catering industries.

These feedstocks essentially contain chemical structures of triglyceride type that a person skilled in the art also knows as fatty acid triester and also as free fatty acids. A fatty acid triester is thus composed of three fatty acid chains. These fatty acid chains in triester form or in free fatty acid form have a number of unsaturations per chain, also known as the number of carbon-carbon double bonds per chain, generally between 0 and 3, but which may be higher notably for oils derived from algae which generally have from 5 to 6 unsaturations per chain.

The molecules present in the feedstocks obtained from renewable sources used in the present invention thus have a number of unsaturations, expressed per triglyceride molecule, advantageously between 0 and 18. In these feedstocks, the degree of unsaturation, expressed as the number of unsaturations per hydrocarbon fatty chain, is advantageously between 0 and 6.

The feedstocks obtained from renewable sources generally also include various impurities and notably heteroatoms such as nitrogen. The nitrogen contents in plant oils are generally between 1 ppm and 100 ppm by weight approximately, depending on their nature.

### Process and Catalysts

Advantageously, the feedstock may undergo, prior to step a) of the process according to the invention, a pretreatment or pre-refining step so as to remove, via a suitable treatment, contaminants such as metals, for instance alkali metal compounds, for example on ion-exchange resins, alkaline-earth metal compounds and phosphorus. Suitable treatments may be, for example, heat treatments and/or chemical treatments that are well known to those skilled in the art.

In accordance with step a) of the process according to the invention, the optionally pretreated feedstock is placed in contact with a catalyst in a fixed bed at a temperature of between 200 and 450° C., preferably between 220 and 350° C., preferably between 220 and 320° C. and even more preferably between 220 and 310° C. The pressure is between 1 MPa and 10 MPa, preferably between 1 MPa and 6 MPa and even more preferably between 1 MPa and 4 MPa. The hourly space velocity, i.e. the volume of feedstock per volume of catalyst and per hour, is between 0.1 h⁻¹ and 10 h⁻¹. The feedstock is placed in contact with the catalyst in the presence of hydrogen. The total amount of hydrogen mixed with the feedstock is such that the hydrogen/feedstock ratio is between 70 and 1000 Nm³ of hydrogen/m³ of feedstock and preferably between 150 and 750 Nm³ of hydrogen/m³ of feedstock.

In step a) of the process according to the invention, the fixed-bed catalyst is advantageously a hydrotreating catalyst comprising a hydro-dehydrogenating function comprising at least one metal from group VIII and/or from group VIB, taken alone or as a mixture, and a support chosen from the group formed by alumina, silica, silica-aluminas, magnesia, clays and mixtures of at least two of these minerals. This support may also advantageously contain other compounds, for example oxides chosen from the group consisting of boron oxide, zirconia, titanium oxide and phosphorus pentoxide. The preferred support is an alumina support and very preferably η, δ or γ alumina.

Said catalyst is advantageously a catalyst comprising metals from group VIII preferably chosen from nickel and cobalt, taken alone or as a mixture, preferably in combination with at least one metal from group VIB preferably chosen from molybdenum and tungsten, taken alone or as a mixture.

The content of oxides of metals from group VIII and preferably of nickel oxide is advantageously between 0.5% and 10% by weight of nickel oxide (NiO) and preferably between 1% and 5% by weight of nickel oxide, and the content of oxides of metals from group VIB and preferably of molybdenum trioxide is advantageously between 1% and 30% by weight of molybdenum oxide (MoO₃), preferably from 5% to 25% by weight, the percentages being expressed as weight percentages relative to the total mass of the catalyst.

The total content of oxides of metals from groups VIB and VIII in the catalyst used in step a) is advantageously between 5% and 40% by weight and preferably between 6% and 30% by weight relative to the total mass of the catalyst.

Said catalyst used in step a) of the process according to the invention must advantageously be characterized by a high hydrogenating power so as to orient the reaction selectivity as much as possible toward a hydrogenation conserving the number of carbon atoms in the fatty chains, i.e. the hydro-deoxygenation route, so as to maximize the yield of hydrocarbons included in the distillation range of kerosenes and/or gas oils. This is why the process is preferably performed at a relatively low temperature. Maximizing the hydrogenating function also makes it possible to limit the polymerization and/or condensation reactions leading to the formation of coke which would degrade the stability of the catalytic performance. A catalyst of Ni or NiMo type is preferably used.

Said catalyst used in the hydrotreating step a) of the process according to the invention may also advantageously contain a doping element chosen from phosphorus and boron, taken alone or as a mixture. Said doping element may be introduced into the matrix or, preferably, may be deposited on the support. Silicon may also be deposited on the support, alone or with phosphorus and/or boron and/or fluorine.

The weight content of oxide of said doping element is advantageously less than 20% and preferably less than 10% and is advantageously at least 0.001%.

Preferred catalysts are the catalysts described in patent application FR 2 943 071 that describes catalysts having a high selectivity for hydro-deoxygenation reactions.

Other preferred catalysts are the catalysts described in patent application EP 2 210 663 that describes supported or bulk catalysts comprising an active phase consisting of a group VIB sulfide element, in which the group VIB element is molybdenum.

The metals of the catalysts used in the hydrotreating step a) of the process according to the invention are sulfurized metals or metallic phases and preferably sulfurized metals.

It would not constitute a departure from the context of the present invention to use in step a) of the process according to the invention, simultaneously or successively, a single catalyst or several different catalysts. This step may be performed industrially in one or more reactors with one or more catalytic beds, preferably with a descending flow of liquid.

Said hydrotreating step a) allows the hydro-deoxygenation, hydro-deazotization and hydro-desulfurization of said feedstock.

In accordance with step b) of the process according to the invention, a step of separating at least a portion and preferably all of the effluent obtained from step a) is performed. Said step b) makes it possible to separate at least a light fraction and at least a hydrocarbon liquid effluent.

Said light fraction comprises at least a gaseous fraction which comprises the unconverted hydrogen and the gases containing at least one oxygen atom obtained from the decomposition of the oxygenated compounds during the hydrotreating step a) and the C₄⁻ compounds, i.e. the C₁ to C₄ compounds preferably having an end boiling point of less than 20° C. The purpose of this step is to separate the gases from the liquid, and notably to recover the hydrogen-rich gases which may also contain gases such as CO and CO₂ and at least a liquid hydrocarbon effluent. Said hydrocarbon liquid effluent preferably has a sulfur content of less than 10 ppm by weight and a nitrogen content of less than 2 ppm by weight.

The separation step b) may advantageously be performed via any method known to those skilled in the art, for instance the combination of one or more high-pressure and/or low-pressure separators, and/or steps of distillation and/or of high-pressure and/or low-pressure stripping.

In accordance with step c) of the process according to the invention, at least a portion and preferably all of the hydrocarbon liquid effluent obtained from the separation step b) undergoes a step of removal of at least a portion and preferably all of the water formed by the hydro-deoxygenation (HDO) reactions which take place during the hydrotreating step b). The purpose of this water-removal step is to separate the water from the hydrocarbon liquid effluent containing the paraffinic hydrocarbons.

Step c) of removing at least a portion of the water and preferably all of the water may advantageously be performed via any method or technique known to those skilled in the art. Preferably, said step c) is performed by drying, by passage over a desiccant, by flash, by decantation or by a combination of at least two of these techniques. The atomic oxygen content of the hydrocarbon liquid effluent containing the paraffinic hydrocarbons obtained from step c) of the process according to the invention, expressed in parts per million by weight (ppm), is preferably less than 500 ppm, preferably less than 300 ppm and very preferably less than 100 ppm by weight. The content in ppm by weight of atomic oxygen in said hydrocarbon liquid effluent is measured via the infrared absorption technique, for instance the technique described in patent application US 2009/0018374 A1.

In accordance with step d) of the process according to the invention, at least a portion and preferably all of the hydrocarbon liquid effluent obtained from step c) of the process according to the invention is converted in the presence of a bifunctional hydroconversion catalyst in a fixed bed, said catalyst comprising a molybdenum and/or tungsten sulfide phase in combination with at least nickel and/or cobalt, said hydroconversion step being performed at a temperature of between 250° C. and 500° C., at a pressure of between 1 MPa and 10 MPa, at an hourly space velocity of between 0.1 and 10 h⁻¹ and in the presence of a total amount of hydrogen mixed with the feedstock such that the hydrogen/feedstock ratio is between 70 and 1000 Nm³/m³ of feedstock, and in the presence of a total amount of sulfur such that the ratio between the partial pressure of hydrogen sulfide and the partial pressure of hydrogen at the inlet of said hydroconversion step is less than 5×10⁻⁵, preferably less than 4×10⁻⁵, very preferably less than 3×10⁻⁵, very preferably less than 2×10⁻⁵ and even more preferably less than 1.5×10⁻⁵.

The sulfur present may originate from the hydrocarbon effluent obtained from step c) and/or from the hydrogen stream mixed with the feedstock in step d). When the sulfur is provided by the hydrocarbon effluent, it is generally in the form of organic sulfur-based molecules, not converted on conclusion of step a) of the process. When the sulfur is provided by the hydrogen, it is generally in the form of hydrogen sulfide. Optionally, sulfur may be provided by adding sulfur-based molecules to the feedstock and/or the hydrogen to keep the hydroconversion catalyst in sulfurized form.

For the purposes of the invention, the ratio of the partial pressures of hydrogen sulfide and of hydrogen is calculated by considering the amount of hydrogen and of sulfur introduced at the inlet of the hydroconversion unit, and considering that all the hydrogen introduced is in the gas phase (any hydrogen that may be dissolved in the feedstock is not considered), that all the sulfur is in the form of hydrogen sulfide (the sulfur-based molecules, if present, are transformed into hydrogen sulfide), and that all the hydrogen sulfide is in the gas phase.

If necessary, said hydrogen stream undergoes a purification step in the case where the hydrogen sulfide content in said hydrogen stream at the inlet of step d) is greater than 50 ppm by volume.

The hydrogen sulfide content in said hydrogen stream may be measured via any method known to those skilled in the art, for instance by gas chromatography or by laser infrared spectrometry proposed, for example, by the company AP2E (ProCeas® H2 purity analyzer).

The hydrogen content in said hydrogen stream may be measured via any method known to those skilled in the art, for instance the thermal conductivity measurement proposed, for example, by the company WITT (Inline Gas Analyzer).

The presence of oxygenated compounds may induce a loss of activity of the hydroconversion catalyst.

Preferably, said hydrogen stream undergoes a purification step in the case where the atomic oxygen content in said hydrogen stream entering the hydroconversion unit is greater than 250 ppm by volume. Preferably, said hydrogen stream undergoes a purification step in the case where the atomic oxygen content in said hydrogen stream is greater than 50 ppm by volume.

Said hydrogen stream used in the process according to the invention and preferably in step d) of the process according to the invention is advantageously generated via the processes known to those skilled in the art, for instance a process of catalytic reforming or of catalytic cracking of gases.

Depending on the nature of the various sources, the hydrogen used in the process according to the invention may or may not contain impurities. The atomic oxygen content in said hydrogen stream may be measured via any method known to those skilled in the art, for instance by gas chromatography.

Preferably, said hydrogen stream may be fresh hydrogen or a mixture of fresh hydrogen and of recycle hydrogen, i.e. of hydrogen not converted during the hydroconversion step d) and/or not converted during the hydrotreating step a) and recycled into step d).

In the case where said hydrogen stream has an atomic oxygen content of greater than 500 ppm by volume, preferably greater than 250 ppm by volume and preferably greater than 50 ppm by volume, said hydrogen stream undergoes a purification step to remove the oxygenated compounds before being introduced into said step d). In the case where said hydrogen stream has a hydrogen sulfide content of greater than 50 ppm by volume, said hydrogen stream undergoes a purification step to remove the hydrogen sulfide before being introduced into said step d).

Said step of purifying the hydrogen stream may advantageously be performed according to any method known to those skilled in the art (see, for example, Z. Du et al., Catalysts, 2021, 11, 393).

Preferably, said purification step is advantageously performed according to the methods of pressure swing adsorption (PSA) or temperature swing adsorption (TSA), amine scrubbing, methanation, preferential oxidation, membrane processes or cryogenic distillation, used alone or in combination.

When the process involves recycling of the hydrogen, purging of the recycle hydrogen may also advantageously be performed so as to limit the accumulation of molecules containing at least one oxygen atom such as carbon monoxide CO or carbon dioxide CO₂ and thus to limit the atomic oxygen content in said hydrogen stream.

Preferably, the atomic oxygen content in said hydrogen stream used in the process according to the invention and preferably in step d) of the process according to the invention, expressed in parts per million by volume (ppmv), must be less than 500 ppmv, preferably less than 250 ppmv and very preferably less than 50 ppmv. The atomic oxygen content in said hydrogen stream is calculated from the concentrations of molecules containing at least one oxygen atom in said hydrogen stream, weighted by the number of oxygen atoms present in said oxygenated molecule. By way of example, considering a hydrogen stream containing CO and CO₂, the content of atomic oxygen contained in said hydrogen stream is then equal to:

$$\\ ppmv ( O ) = ppmv ( CO ) + 2 * ppmv ( {CO}_{2} ) with :$$

$$\\ ppmv ( O ) atomic oxygen content in the hydrogen stream$$

$$\\ in parts per million by volume ,$$

$$\\ ppmv ( CO ) carbon monoxide content in the hydrogen stream$$

$$\\ in parts per million by volume ,$$

$$\\ ppmv ( {CO}_{2} ) carbon dioxide content in the hydrogen stream$$

$$\\ in parts per million by volume .$$

In the case where said hydrogen stream has an atomic oxygen content of less than 500 ppmv, preferably less than 250 ppmv and preferably less than 50 ppmv, no step of purification of said hydrogen stream is performed before said stream is introduced into said step d).

The operating conditions of the hydroconversion step d) are adjusted to promote the hydroisomerization or hydrocracking reactions as need be. Preferably, the hydroconversion step d) of the process according to the invention operates at a temperature of between 250° C. and 450° C. and very preferably between 250° C. and 400° C., at a pressure of between 2 MPa and 10 MPa and very preferably of between 1 MPa and 9 MPa, at an hourly space velocity of between 0.2 and 7 h⁻¹ and very preferably between 0.5 and 5 h⁻¹, at a hydrogen flow rate such that the hydrogen/feedstock volume ratio is advantageously between 100 and 1000 normal m³ of hydrogen per m³ of feedstock and preferably between 150 and 1000 normal m³ of hydrogen per m³ of feedstock. The hydroconversion step d) of the process according to the invention takes place with a ratio between the partial pressure of hydrogen sulfide and of hydrogen of less than 5×10⁻⁵, preferably less than 4×10⁻⁵, very preferably less than 3×10⁻⁵, very preferably less than 2×10⁻⁵ and even more preferably less than 1.5×10⁻⁵.

In accordance with the invention, the hydroconversion catalyst comprises at least tungsten and/or molybdenum in combination with at least nickel and/or cobalt.

The content of tungsten and/or molybdenum is advantageously, as oxide equivalent, between 5% and 50% by weight relative to the finished catalyst, preferably between 10% and 40% by weight and very preferably between 15% and 35% by weight, and the nickel and/or cobalt content of said catalyst is advantageously, as oxide equivalent, between 0.5% and 10% by weight relative to the finished catalyst, preferably between 1% and 8% by weight and very preferably between 1.5% and 6% by weight. Said catalyst is used in its sulfurized form.

Preferably, the catalyst comprises tungsten in combination with nickel.

The metals are advantageously introduced into the catalyst via any method known to those skilled in the art, for instance co-kneading, dry impregnation or impregnation by exchange.

The hydroconversion catalyst also advantageously comprises at least one acidic solid and optionally a binder.

Preferably, the acidic solid is a Brønsted acid preferably chosen from silica-alumina, zeolite Y, SAPO-11, SAPO-41, ZSM-22, ferrierite, ZSM-23, ZSM-48, ZBM-30, IZM-1 and COK-7. Preferably, the acidic solid is silica-alumina.

Optionally, a binder may also advantageously be used during the step of forming the support. A binder is preferably used when zeolite is employed.

Said binder is advantageously chosen from silica (SiO₂), alumina (Al₂O₃), clays, titanium oxide (TiO₂), boron oxide (B₂O₃) and zirconia (ZrO₂), taken alone or as a mixture. Preferably, said binder is chosen from silica and alumina and even more preferably said binder is alumina in all its forms known to those skilled in art, for instance y-alumina.

A preferred catalyst used in the process according to the invention comprises a silica-alumina and at least tungsten and/or molybdenum and at least nickel and/or cobalt, said catalyst being sulfurized. The content of tungsten and/or molybdenum is advantageously, as oxide equivalent, between 5% and 50% by weight relative to the finished catalyst, preferably between 10% and 40% by weight and very preferably between 15% and 35% by weight, and the nickel and/or cobalt content of said catalyst is advantageously, as oxide equivalent, between 0.5% and 10% by weight relative to the finished catalyst, preferably between 1% and 8% by weight and very preferably between 1.5% and 6% by weight. The content of elements is perfectly measured by means of X-ray fluorescence.

A preferred catalyst used in the process according to the invention comprises a particular silica-alumina, said silica-alumina having:
alumina and silica with a mass content of silica (SiO₂) of greater than 5% by weight and less than or equal to 95% by weight, preferably between 10% and 80% by weight, preferably a silica content of greater than 20% by weight and less than 80% by weight and even more preferably greater than 25% by weight and less than 75% by weight; the silica content is advantageously between 10% and 50% by weight,
a BET specific surface area of from 100 m²/g to 500 m²/g, preferably between 200 m²/g and 450 m²/g and very preferably between 200 m²/g and 300 m²/g,
a mean diameter of the mesopores, measured by mercury porosimetry, of between 3 nm and 12 nm, preferably of between 3 nm and 11 nm and very preferably between 4 nm and 10.5 nm,
a total pore volume, measured by mercury porosimetry, of between 0.4 and 1.2 ml/g, preferably between 0.4 and 1.0 ml/g and very preferably between 0.4 and 0.8 ml/g,
a volume of macropores, the diameter of which is greater than 50 nm, of less than 0.002 ml/g.

The mean diameter of the mesopores is defined as being the diameter corresponding to the cancellation of the curve derived from the mercury intrusion volume obtained from the mercury porosity curve for pore diameters of between 2 and 50 nm.

Preferably, the coefficient of distribution of the metals of said preferred catalyst is greater than 0.1, preferably greater than 0.2 and very preferably greater than 0.4. The coefficient of distribution represents the distribution of the metal inside the catalyst grain. The coefficient of distribution of the metals may be measured with a Castaing microprobe.

In accordance with step e) of the process according to the invention, the effluent obtained from step d) undergoes a fractionation step, preferably in a distillation train which incorporates atmospheric distillation and optionally vacuum distillation, to obtain at least a middle distillate fraction.

The aim of said step e) is to separate the gases from the liquid, and notably to recover the hydrogen-rich gases which may also contain light fractions such as the C₁-C₄ cut and at least a gas oil cut, at least a kerosene cut and at least a naphtha cut. The economic exploitation of the naphtha cut is not the purpose of the invention, but this cut may advantageously be sent into a steam cracking or catalytic reforming unit.

### DESCRIPTION OF THE FIGURES

FIG. 1 shows the evolution of the cloud point of the liquid effluent as a function of time during the hydroconversion in example 4.

FIG. 2 shows the evolution of the cloud point of the liquid effluent as a function of time during the hydroconversion in example 7.

FIG. 3 shows the evolution of the cloud point of the liquid effluent as a function of time during the hydroconversion in example 8.

FIG. 4 shows the evolution of the cloud point of the liquid effluent as a function of time during the hydroconversion in example 9.

### EXAMPLES

### Example 1: Preparation of a Hydrotreating Catalyst (C1)

The catalyst is an industrial catalyst based on nickel, molybdenum and phosphorus on alumina with contents of molybdenum oxide MoO₃ of 22% by weight, of nickel oxide NiO of 4% by weight and of phosphorus oxide P₂O₅ of 5% by weight relative to the total weight of the finished catalyst, sold by the company Axens.

### Example 2: Preparation of a Hydroconversion Catalyst in Accordance With the Invention (C2)

The silica-alumina powder is prepared according to the synthetic protocol described in patent EP 1 415 712 A. The amounts of orthosilicic acid and of aluminum hydrate are chosen so as to have a composition containing 70% by weight of alumina Al₂O₃ and 30% by weight of silica SiO₂ in the final solid.

This mixture is rapidly homogenized in a commercial colloidal mill in the presence of nitric acid so that the nitric acid content of the suspension leaving the mill is 8% relative to the silica-alumina mixed solid. Next, the suspension is dried conventionally in an atomizer conventionally from 300° C. to 60° C. The powder thus prepared is formed in a Z-shaped arm in the presence of 8% nitric acid relative to the anhydrous product. The extrusion is performed by passing the paste through a die equipped with orifices 1.4 mm in diameter. The extrudates thus obtained are oven-dried at 140° C., then calcined under a stream of dry air at 550° C. and then calcined at 850° C. in the presence of steam.

The characteristics of the support thus prepared are as follows:
a mean mesopore diameter, measured by mercury porosimetry, of 7.7 nm,
a total pore volume of 0.49 ml/g,
a mesopore volume of 0.47 ml/g,
a volume of macropores, the diameter of which is greater than 50 nm, of less than 0.01 ml/g,
a BET surface area of 240 m²/g.

The silica-alumina extrudates are then subjected to a step of dry impregnation with an aqueous solution of ammonium metatungstate and nickel nitrate, left to mature in a water maturator for 24 hours at room temperature and then calcined for 2 hours in dry air in a bed traversed at 450° C. (temperature increase ramp of 5° C./minute). The weight content of tungsten oxide WO₃ of the finished catalyst after calcination is 27%, and the content of nickel oxide NiO is 3.5%. The distribution coefficient of the metals, measured with a Castaing microprobe, is equal to 0.93.

### Example 3: Hydrotreating of a Feedstock Obtained From a Renewable Source According to a Process in Accordance With the Invention

Pre-refined rapeseed oil with a density of 920 kg/m³, having an oxygen content of 11% by weight, is hydrotreated in a reactor which is temperature-regulated so as to ensure isothermal functioning and with a fixed bed containing 190 ml of hydrotreating catalyst C1, the catalyst being sulfurized beforehand. The cetane number is 35 and the fatty acid distribution of the rapeseed oil is detailed in table 1. Prior to the hydrotreating step, said feedstock is supplemented with dimethyl disulfide so as to adjust its sulfur content to 50 ppm by weight.

TABLE 1
Characteristics of the rapeseed oil used as feedstock
for the hydrotreating

| Fatty acid composition | (%) |
|---|---|
| 14:0 | 0.1 |
| 16:0 | 5.0 |
| 16:1 | 0.3 |
| 17:0 | 0.1 |
| 17:1 | 0.1 |
| 18:0 | 1.5 |
| 18:1 trans | <0.1 |
| 18:1 cis | 60.1 |
| 18:2 trans | <0.1 |
| 18:2 cis | 20.4 |
| 18:3 trans | <0.1 |
| 18:3 cis | 9.6 |
| 20:0 | 0.5 |
| 20:1 | 1.2 |
| 22:0 | 0.3 |
| 22:1 | 0.2 |
| 24:0 | 0.1 |
| 24:1 | 0.2 |

Before hydrotreating the feedstock, the catalyst is sulfurized in situ in the unit, with a distillation gas oil supplemented with 2% by weight of dimethyl disulfide, under a total pressure of 5.1 MPa, a hydrogen/supplemented gas oil ratio of 700 Nm³ per m³. The volume of supplemented gas oil per volume of catalyst and per hour is set at 1 h⁻¹. Sulfurization is performed for 12 hours at 350° C., with a temperature increase ramp of 10° C. per hour.

After sulfurization, the operating conditions of the unit are adjusted so as to perform the hydrotreating of the feedstock:
HSV (volume of feedstock/volume of catalyst/hour): 1 h⁻¹.
total working pressure: 5.1 MPa,
hydrogen/feedstock ratio: 700 Nm³ of hydrogen/m³ of feedstock,
temperature: 310° C.

The hydrogen employed is supplied by Air Products and has a purity of greater than 99.999% by volume.

### Steps b) and c): Separation of the Effluent Obtained From Step a)

All of the hydrotreated effluent obtained from step a) is separated using a gas/liquid separator so as to recover a light fraction predominantly containing hydrogen, propane, water in vapor form, carbon oxides (CO and CO₂) and ammonia, and a liquid hydrocarbon effluent predominantly consisting of linear hydrocarbons. The water present in the liquid hydrocarbon effluent is removed by decantation. The liquid hydrocarbon effluent thus obtained has an atomic oxygen content of less than 80 ppm by weight, said atomic oxygen content being measured via the infrared adsorption technique described in patent application US 2009/0018374, and a sulfur content of 2 ppm by weight and a nitrogen content of less than 1 ppm by weight, said nitrogen and sulfur contents being measured, respectively, by chemiluminescence and by UV fluorescence. Said liquid hydrocarbon effluent has a density of 791 kg/m³. The liquid hydrocarbon effluent is composed of paraffins; its composition, measured by gas chromatography, is given in table 2.

TABLE 2
composition of the liquid hydrocarbon effluent used as
feedstock for the hydroconversion

| Distribution of the | |
|---|---|
| n-paraffins by carbon | |
| number | (% m/m) |
| nC8 | 0.01 |
| nC9 | 0.00 |
| nC10 | 0.01 |
| nC11 | 0.01 |
| nC12 | 0.01 |
| nC13 | 0.02 |
| nC14 | 0.06 |
| nC15 | 0.97 |
| nC16 | 4.09 |
| nC17 | 17.70 |
| nC18 | 72.77 |
| nC19 | 0.67 |
| nC20 | 1.56 |
| nC21 | 0.18 |
| nC22 | 0.56 |
| nC23 | 0.09 |
| nC24 | 0.23 |
| nC25 | 0.02 |
| nC26 | 0.02 |

### Example 4: Hydroconversion of the Liquid Hydrocarbon Effluent Obtained From Example 3 According to a Process Not in Accordance With the Invention

Hydroconversion of the liquid hydrocarbon effluent obtained from example 3 is performed in a reactor which is temperature-regulated so as to ensure isothermal functioning and with a fixed bed containing 50 ml of hydroconversion catalyst C2, the catalyst being sulfurized beforehand. Sulfur is introduced beforehand in the form of dimethyl disulfide into said liquid hydrocarbon effluent, so as to obtain a total sulfur content of 500 ppm by weight in said liquid hydrocarbon effluent.

The catalyst C2 undergoes a step of in situ sulfurization in the unit, with Isane supplemented with 2% by weight of dimethyl disulfide, under a total pressure of 5.1 MPa, a hydrogen/supplemented Isane ratio of 350 Nm³ per m³. The volume of supplemented Isane per volume of catalyst and per hour is set at 1 h⁻¹. Sulfurization is performed for 12 hours at 350° C., with a temperature increase ramp of 10° C. per hour.

After sulfurization, the operating conditions of the unit are adjusted so as to perform the hydroconversion of the liquid hydrocarbon effluent containing 500 ppm by weight of sulfur:
HSV (volume of feedstock/volume of catalyst/hour)=1 h⁻¹.
total working pressure: 5.1 MPa,
hydrogen/feedstock ratio: 700 Nm³ of hydrogen/m³ of feedstock.

The hydrogen stream used and entering the hydroconversion step is supplied by Air Products: it has a purity of greater than 99.999% and is free of hydrogen sulfide. The ratio between the partial pressure of hydrogen sulfide and the partial pressure of hydrogen is then equal to 4×10⁻⁴.

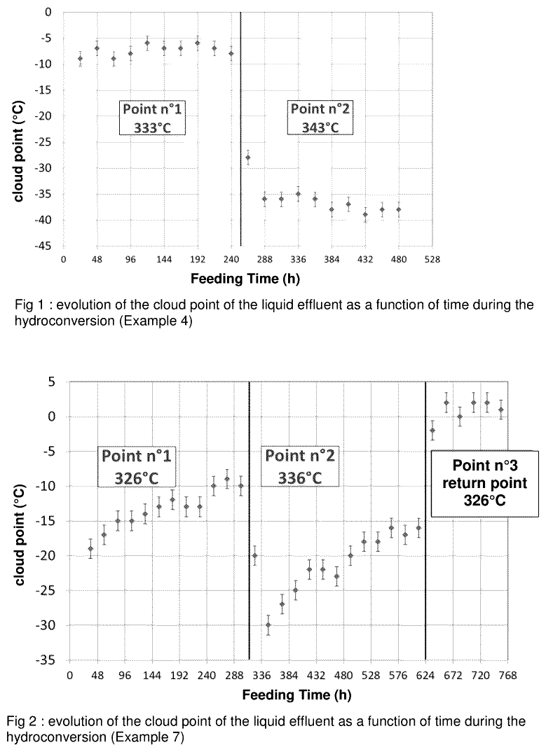

Steady temperature stages at 333 and 343° C. are applied so as to vary the severity of the hydroconversion. Measurement (typically daily) of the cloud point (via the method ASTM D5773) of the liquid effluent makes it possible to monitor the change in performance of the catalyst at each steady temperature stage. For each temperature, the test time is prolonged until a stable cloud point is obtained. Once stability of the cloud point is achieved, the liquid effluent is accumulated for 24 hours. Under the chosen operating conditions, no deactivation of the catalyst is observed (see FIG. 1).

At the unit outlet, inline analysis by gas chromatography and a gas counter makes it possible to calculate the mass of light hydrocarbons produced (essentially hydrocarbons containing 1 to 5 carbon atoms) and present in the hydrogen stream. Said liquid effluent is subsequently weighed and then fractionated by distillation so as to determine the yield of middle distillate (130° C.⁺ cut, corresponding to hydrocarbons with a boiling point of more than 130° C.).

The middle distillate yield is calculated as follows:

$$\\ Yield ( middle distillate ) = [ \begin{matrix}( mass of liquid effluent \times {\%130}^{+} cut / 100 ) / \\ ( mass of liquid effluent + mass of light hydrocarbons )\end{matrix} ] \times 100$$

Moreover, the cloud point and the motor cetane number of the middle distillate cut are determined, respectively, via the method ASTM D5773 and via the CFR method ASTM D613.

The main characteristics of the effluents produced and the associated operating conditions are reported in Table 3.

### Example 5: Hydroconversion of the Liquid Hydrocarbon Effluent Obtained From Example 3 According to a Process in Accordance With the Invention

Hydroconversion of the liquid hydrocarbon effluent obtained from example 3 is performed in a reactor which is temperature-regulated so as to ensure isothermal functioning and with a fixed bed containing 50 ml of hydroconversion catalyst C2, the catalyst being sulfurized beforehand. Sulfur is introduced beforehand in the form of dimethyl disulfide into said liquid hydrocarbon effluent, so as to obtain a total sulfur content of 50 ppm by weight in said liquid hydrocarbon effluent.

The catalyst C2 undergoes a sulfurization step identical to that reported in example 4.

After sulfurization, the operating conditions of the unit are adjusted so as to perform the hydroconversion of the liquid hydrocarbon effluent containing 50 ppm by weight of sulfur:
HSV (volume of feedstock/volume of catalyst/hour)=1 h⁻¹.
total working pressure: 5.1 MPa,
hydrogen/feedstock ratio: 700 Nm³ of hydrogen/m³ of feedstock.

The operating conditions are thus the same as those of example 4, only the sulfur content in the liquid hydrocarbon effluent is different.

The hydrogen stream used and entering the hydroconversion step is supplied by Air Products: it has a purity of greater than 99.999% by volume and is free of hydrogen sulfide. The ratio between the partial pressure of hydrogen sulfide and the partial pressure of hydrogen is then equal to 4× 10⁻⁵.

The steady temperature stages are adjusted so as to obtain middle distillate cloud points that are comparable to those obtained in example 4. Measurement (typically daily) of the cloud point of the liquid effluent makes it possible to monitor the change in performance of the catalyst at each steady temperature stage. For each temperature, the test time is prolonged until a stable cloud point is obtained. Once stability of the cloud point is achieved, the liquid effluent is accumulated for 24 hours. Under the chosen operating conditions, no deactivation of the catalyst is observed.

Said liquid effluent is subsequently weighed and then fractionated by distillation so as to determine the yield of middle distillate in the manner reported in example 4.

The main characteristics of the effluents produced and the associated operating conditions are reported in Table 3. It is observed that, in comparison with the non-compliant example 4, the reduction in the ratio P(H₂S)/P(H₂) makes it possible to improve the activity of the catalyst. Specifically, the temperature required to achieve a comparable cloud point value is 2 to 3° lower. Furthermore, reducing the ratio P(H₂S)/P(H₂) also makes it possible to improve the selectivity of the catalyst since, for a comparable cloud point value, the yield of middle distillate increases by 5 points.

### Example 6: Hydroconversion of the Liquid Hydrocarbon Effluent Obtained From Example 3 According to a Process in Accordance With the Invention

Hydroconversion of the liquid hydrocarbon effluent obtained from example 3 is performed in a reactor which is temperature-regulated so as to ensure isothermal functioning and with a fixed bed containing 50 ml of hydroconversion catalyst C2, the catalyst being sulfurized beforehand. Sulfur is introduced beforehand in the form of dimethyl disulfide into said liquid hydrocarbon effluent, so as to obtain a total sulfur content of 15 ppm by weight in said liquid hydrocarbon effluent.

The catalyst C2 undergoes a sulfurization step identical to that reported in example 4.

After sulfurization, the operating conditions of the unit are adjusted so as to perform the hydroconversion of the liquid hydrocarbon effluent containing 50 ppm by weight of sulfur:
HSV (volume of feedstock/volume of catalyst/hour)=1 h⁻¹.
total working pressure: 5.1 MPa,
hydrogen/feedstock ratio: 700 Nm³ of hydrogen/m³ of feedstock.

The operating conditions are thus the same as those of example 4, only the sulfur content in the liquid hydrocarbon effluent is different.

The hydrogen stream used and entering the hydroconversion step is supplied by Air Products: it has a purity of greater than 99.999% by volume and is free of hydrogen sulfide. The ratio between the partial pressure of hydrogen sulfide and the partial pressure of hydrogen is then equal to 1.2×10⁻⁵.

The steady temperature stages are adjusted so as to obtain middle distillate cloud points that are comparable to those obtained in example 4. Measurement (typically daily) of the cloud point of the liquid effluent makes it possible to monitor the change in performance of the catalyst at each steady temperature stage. For each temperature, the test time is prolonged until a stable cloud point is obtained. Once stability of the cloud point is achieved, the liquid effluent is accumulated for 24 hours. Under the chosen operating conditions, no deactivation of the catalyst is observed.

Said liquid effluent is subsequently weighed and then fractionated by distillation so as to determine the yield of middle distillate in the manner reported in example 4.

The main characteristics of the effluents produced and the associated operating conditions are reported in Table 3. It is observed that, in comparison with the non-compliant example 4, the reduction in the ratio P(H₂S)/P(H₂) makes it possible to improve the activity of the catalyst. Specifically, the temperature required to achieve a comparable cloud point value is 5 to 6° lower. Furthermore, reducing the ratio P(H₂S)/P(H₂) also makes it possible to improve the selectivity of the catalyst since, for a comparable cloud point value, the yield of middle distillate increases by 6 points.

TABLE 3
Main characteristics of the effluents produced by
hydroconversion and associated operating conditions

| Example | 4 (non-compliant) | | 5 (in accordance) | | 6 (in accordance) | |
|---|---|---|---|---|---|---|
| Reaction | 333 | 343 | 331 | 340 | 328 | 337 |
| temperature (° C.) | | | | | | |
| HSV (h⁻¹) | 1 | 1 | 1 | 1 | 1 | 1 |
| Total pressure | 5.1 | 5.1 | 5.1 | 5.1 | 5.1 | 5.1 |
| (MPa) | | | | | | |
| H₂/feedstock | 700 | 700 | 700 | 700 | 700 | 700 |
| (Nm³/m³) | | | | | | |
| P(H₂S)/P(H₂) | 4 × 10⁻⁴ | 4 × 10⁻⁴ | 4 × 10⁻⁵ | 4 × 10⁻⁵ | 1.2 × 10⁻⁵ | 1.2 × 10⁻⁵ |
| Yield of middle | 83 | 61 | 88 | 66 | 89 | 67 |
| distillate (weight %) | | | | | | |
| Cloud point of the | −4 | −35 | −4 | −36 | −5 | −35 |
| middle distillate (° C.) | | | | | | |
| Cetane number of | 78 | 69 | 78 | 68 | 77 | 69 |
| the middle distillate | | | | | | |

### Example 7: Hydroconversion of the Liquid Hydrocarbon Effluent Obtained From Example 3 According to a Process Not in Accordance With the Invention

Hydroconversion of the liquid hydrocarbon effluent obtained from example 3 is performed in a reactor which is temperature-regulated so as to ensure isothermal functioning and with a fixed bed containing 50 ml of hydroconversion catalyst C2, the catalyst being sulfurized beforehand. Sulfur is introduced beforehand in the form of dimethyl disulfide into said liquid hydrocarbon effluent, so as to obtain a total sulfur content of 50 ppm by weight in said liquid hydrocarbon effluent.

The catalyst C2 undergoes a step of in situ sulfurization in the unit, with Isane supplemented with 2% by weight of dimethyl disulfide, under a total pressure of 5.1 MPa, a hydrogen/supplemented gas oil ratio of 700 Nm³ per m³. The volume of supplemented Isane per volume of catalyst and per hour is set at 1 h⁻¹. Sulfurization is performed for 12 hours at 350° C., with a temperature increase ramp of 10° C. per hour.

After sulfurization, the operating conditions of the unit are adjusted so as to perform the hydroconversion of the liquid hydrocarbon effluent containing 50 ppm by weight of sulfur:
HSV (volume of feedstock/volume of catalyst/hour)=0.6 h⁻¹.
total working pressure: 2.8 MPa,
hydrogen/feedstock ratio: 470 Nm³ of hydrogen/m³ of feedstock.

The hydrogen stream used in the hydroconversion step is supplied by Air Products: it has a purity of greater than 99.999% by volume and is free of hydrogen sulfide. The ratio between the partial pressure of hydrogen sulfide and the partial pressure of hydrogen is then equal to 6×10⁻⁵.

In comparison with examples 4 and 5, the operating conditions chosen are more stringent with respect to the stability of the catalyst. Without wishing to be bound by any theory, the Applicant thinks that the reduction in the total working pressure and in the hydrogen/feedstock ratio may promote deactivation by coking of the catalyst.

Steady temperature stages at 326 and then 336° C. are applied so as to vary the severity of the hydroconversion, and a return point is applied at 326° C. to evaluate the deactivation of the catalyst. Regular measurement (typically daily) of the cloud point of the liquid effluent makes it possible to monitor the change in performance of the catalyst at each steady temperature stage. For each temperature, the test time is prolonged until a stable cloud point is obtained. Once stability of the cloud point is achieved, the liquid effluent is accumulated for 24 hours. Said liquid effluent is subsequently weighed and then fractionated by distillation so as to determine the yield of middle distillate in the manner reported in example 4.

FIG. 2 represents the change in the daily measurement of the liquid effluent in the course of the test. Under the chosen operating conditions, the catalyst undergoes deactivation at each test temperature, as evidenced by the increase in the cloud point value between the start and the end of each steady temperature stage. For example, at the first point at 326° C., the cloud point increases from −19° C. (after 36 hours) to −10° C. at 252 hours, at which value the activity of the catalyst becomes stable. Deactivation is also observed at the second point (steady temperature stage at 336° C.). Finally, the return point applied at 326° C. confirms the deactivation of the catalyst: the cloud point stabilizes at 1° C., as opposed to −10° C. as the stabilized value at the end of the first point. The increase in the cloud point between the first measured value and the last measured value is employed to evaluate the deactivation of the catalyst:

$$Deactivation of the catalyst = final cloud point ( ° C . ) - initial clod point ( ° C . )$$

The deactivation of the catalyst and the main characteristics of the effluents produced and the operating conditions associated with point No. 1 and point No. 2 are reported in table 4.

### Example 8: Hydroconversion of the Liquid Hydrocarbon Effluent Obtained From Example 3 According to a Process in Accordance With the Invention

Hydroconversion of the liquid hydrocarbon effluent obtained from example 3 is performed in a reactor which is temperature-regulated so as to ensure isothermal functioning and with a fixed bed containing 50 ml of hydroconversion catalyst C2, the catalyst being sulfurized beforehand. Sulfur is introduced beforehand in the form of dimethyl disulfide into said liquid hydrocarbon effluent, so as to obtain a total sulfur content of 10 ppm by weight in said liquid hydrocarbon effluent.

The catalyst C2 undergoes a sulfurization step identical to that reported in example 6.

After sulfurization, the operating conditions of the unit are adjusted so as to perform the hydroconversion of the liquid hydrocarbon effluent containing 11 ppm by weight of sulfur:
HSV (volume of feedstock/volume of catalyst/hour)=0.6 h⁻¹.
total working pressure: 2.8 MPa,
hydrogen/feedstock ratio: 470 Nm³ of hydrogen/m³ of feedstock.

The operating conditions are thus the same as those of example 6, only the sulfur content in the liquid hydrocarbon effluent is different.

The hydrogen stream used in the hydroconversion step is supplied by Air Products: it has a purity of greater than 99.999% by volume and is free of hydrogen sulfide. The ratio between the partial pressure of hydrogen sulfide and the partial pressure of hydrogen is then equal to 1.2×10⁻⁵.

Steady temperature stages at 326 and then 336° C. are applied so as to vary the severity of the hydroconversion, and a return point is applied at 326° C. to evaluate the deactivation of the catalyst. Regular measurement (typically daily) of the cloud point of the liquid effluent makes it possible to monitor the change in performance of the catalyst at each steady temperature stage. For each temperature, the test time is prolonged until a stable cloud point is obtained. Once stability of the cloud point is achieved, the liquid effluent is accumulated for 24 hours.

Said liquid effluent is subsequently weighed and then fractionated by distillation so as to determine the yield of middle distillate in the manner reported in example 4.

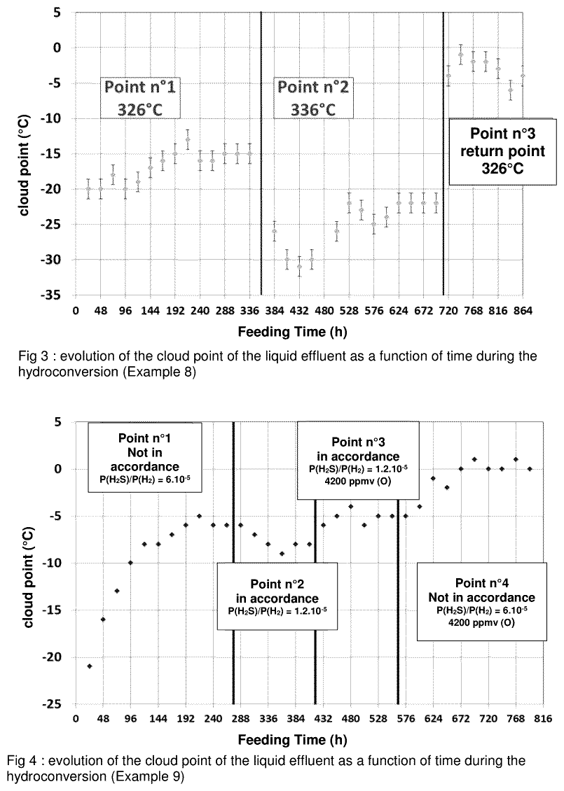

FIG. 3 represents the change in the daily measurement of the liquid effluent in the course of the test. Under the chosen operating conditions, the catalyst undergoes deactivation at each test temperature, just as is observed in the non-compliant example 7. However, the deactivation is less pronounced than in example 7. For example, at the first point at 326° C., the cloud point increases from −20° C. (after 24 hours) to −15° C. at 288 hours, at which value the activity of the catalyst becomes stable. Deactivation is also observed at the second point (steady temperature stage at 336° C.). Lower deactivation of the catalyst makes it possible to achieve lower stabilized cloud point values than in example 6: −15° C. at the end of point 1 (as opposed to −10° C. in example 6), −22° C. at the end of point 2 (as opposed to −16° C. in example 6). Finally, the stabilized cloud point value at point 3 (return point) confirms the lower deactivation: −4° C. as opposed to +1° C. in example 6.

The deactivation of the catalyst and the main characteristics of the effluents produced and the associated operating conditions are reported in Table 4. It is observed that, in comparison with the non-compliant example 6, the reduction in the ratio P(H₂S)/P(H₂) allows, all factors being otherwise equal, multiple gains when the operating conditions bring about deactivation of the catalyst. Firstly, in comparison with the non-compliant example 6, the deactivation is lower. Secondly, for a given reaction temperature, the decrease in the ratio P(H₂S)/P(H₂) makes it possible to improve both the yield of middle distillate and the cold properties of said middle distillate.

TABLE 4
Main characteristics of the effluents produced by hydroconversion and
associated operating conditions

| Example | 7 (non-compliant) | | 8 (in accordance) | |
|---|---|---|---|---|
| Deactivation (° C.) | 20 | | 16 | |
| Reaction temperature | 326 | 336 | 326 | 336 |
| (°C.) | | | | |
| HSV (h⁻¹) | 0.6 | 0.6 | 0.6 | 0.6 |
| Total pressure (MPa) | 2.8 | 2.8 | 2.8 | 2.8 |
| H₂/feedstock (Nm³/m³) | 470 | 470 | 470 | 470 |
| P(H₂S)/P(H₂) | 6.0 × 10⁻⁵ | 6.0 × 10⁻⁵ | 1.2 × 10⁻⁵ | 1.2 × 10⁻⁵ |
| Yield of middle distillate | 80 | 72 | 81 | 75 |
| (weight %) | | | | |
| Cloud point of the | −10 | −17 | −15 | −22 |
| middle distillate (° C.) | | | | |
| Cetane number of the | 76 | 74 | 75 | 73 |
| middle distillate | | | | |

### Example 9: Hydroconversion of the Liquid Hydrocarbon Effluent Obtained From Example 3 According to a Process in Accordance With the Invention

During the use of the catalyst in the industrial hydroconversion unit, it may arise that the ratio P(H₂S)/P(H₂) is not in accordance with the invention over certain periods, for example on account of sporadic poor functioning of the tools that may be used for purifying the hydrogen sent into the unit and/or the liquid hydrocarbon effluent obtained from step c). Readjusting the ratio P(H₂S)/P(H₂) to within a range in accordance with the invention, after functioning under non-compliant conditions, also makes it possible to improve the performance of the catalyst, as illustrated below.

Hydroconversion of the liquid hydrocarbon effluent obtained from example 3 is performed in a reactor which is temperature-regulated so as to ensure isothermal functioning and with a fixed bed containing 50 ml of hydroconversion catalyst C2, the catalyst being sulfurized beforehand.

The catalyst C2 undergoes a sulfurization step identical to that reported in example 6.

After sulfurization, the step of hydroconversion of the liquid hydrocarbon effluent obtained from example 3 is performed under various operating conditions, some of which simulate temporary functioning of the unit not in accordance with the invention over certain periods. Table 5 reports the various operating conditions applied. Throughout the test, the temperature, the total pressure, the hydrogen/feedstock ratio and the HSV are kept constant. Points 1 and 4 are not in accordance with the invention on account of their excessively high ratio P(H₂S)/P(H₂) (supplementation of the feedstock with dimethyl disulfide), whereas points 2 and 3 are compliant. For points 2 and 4, oxygenated impurities are also present in the hydrogen stream. This is performed by using a calibration mixture containing hydrogen, carbon monoxide and carbon dioxide supplied by Air Products. The content of atomic O contained in the hydrogen stream is then 4200 ppm by volume. Regular measurement (typically daily) of the cloud point of the liquid effluent makes it possible to monitor the change in performance of the catalyst at each steady temperature stage. For each temperature, the test time is prolonged until a stable cloud point is obtained. Once stability of the cloud point is achieved, the liquid effluent is accumulated for 24 hours. Said liquid effluent is subsequently weighed and then fractionated by distillation so as to determine the yield of middle distillate in the manner reported in example 4.

FIG. 4 represents the change in the daily measurement of the liquid effluent in the course of the test. Under the chosen operating conditions, the catalyst undergoes deactivation at the first test point (non-compliant), just as is observed in examples 7 and 8. It is observed that the cloud point stabilizes at a value of −6° C. All factors being otherwise equal, adjusting the ratio P(H₂S)/P(H₂) to a value in accordance with the invention, at point 2, enables the catalyst to regain activity. At point 2, the cloud point stabilizes at −8° C. At point 3, the addition of oxygenated compounds to the hydrogen induces a loss of activity of the catalyst, the cloud point then stabilizing at −5° C. At point 4, all factors being otherwise equal, adjusting the ratio P(H₂S)/P(H₂) to a value not in accordance with the invention also induces a loss of activity of the catalyst, the cloud point then stabilizing at a 0° C. Whether in the presence or in the absence of oxygenated compounds, it thus appears advantageous to work within a P(H₂S)/P(H₂) ratio range in accordance with the invention.

Finally, table 5 reports the main characteristics of the effluents produced at each operating point, when the unit is stabilized. Here also, the operating mode in accordance with the invention is advantageous. All factors being otherwise equal, adjusting the ratio P(H₂S)/P(H₂) to values in accordance with the invention makes it possible both to gain in yield of middle distillate and also to improve the cold properties of said middle distillate (comparison of point 1 and point 2 and comparison of point 3 and point 4).

TABLE 5
Main characteristics of the effluents produced by hydroconversion and associated
operating conditions for example 9

| | Point No. 1 | Point No. 2 | Point No. 3 | Point No. 4 |
|---|---|---|---|---|
| Operating | Not in accordance | In accordance | In accordance | Not in accordance |
| mode | with the invention | with the invention | with the invention | with the invention |
| Comment | Supplementation | Supplementation | Supplementation | Supplementation |
| | of the liquid | of the liquid | of the liquid | of the liquid |
| | hydrocarbon | hydrocarbon | hydrocarbon | hydrocarbon |
| | effluent obtained | effluent obtained | effluent obtained | effluent obtained |
| | from example 3 | from example 3 | from example 3 | from example 3 |
| | with dimethyl | with dimethyl | with dimethyl | with dimethyl |
| | disulfide to obtain | disulfide to obtain | disulfide to obtain | disulfide to obtain |
| | 50 ppm by weight | 10 ppm by weight | 10 ppm by weight | 50 ppm by weight |
| | of sulfur in said | of sulfur in said | of sulfur in said | of sulfur in said |
| | effluent | effluent | effluent | effluent |
| | | | Use of hydrogen | Use of hydrogen |
| | | | with oxygenated | with oxygenated |
| | | | impurities | impurities |
| | | | (CO and CO₂) | (CO and CO₂) |
| Reaction | 333 | 333 | 333 | 333 |
| temperature | | | | |
| (° C.) | | | | |
| HSV (h⁻¹) | 1.0 | 1.0 | 1.0 | 1.0 |
| Total pressure | 2.8 | 2.8 | 2.8 | 2.8 |
| (MPa) | | | | |
| H₂/feedstock | 470 | 470 | 470 | 470 |
| (Nm³/m³) | | | | |
| Composition | >99.999% | >99.999% | 99.66% volume | 99.66% volume |
| of the | volume H₂ | volume H₂ | H₂ | H₂ |
| hydrogen | | | 0.26% volume CO | 0.26% volume CO |
| stream | | | 0.08% volume | 0.08% volume |
| | | | CO₂ | CO₂ |
| | | | 4200 ppm O | 4200 ppm O |
| P(H₂S)/P(H₂) | 6.0 × 10⁻⁵ | 1.2 × 10⁻⁵ | 1.2 × 10⁻⁵ | 6.0 × 10⁻⁵ |
| Yield of middle | 81 | 84 | 88 | 85 |
| distillate | | | | |
| (weight %) | | | | |
| Cloud point of | −5 | −7 | −3 | 3 |
| the middle | | | | |
| distillate (° C.) | | | | |
| Cetane | 77 | 77 | 78 | 80 |
| number of the | | | | |
| middle | | | | |
| distillate | | | | |

1. A process for treating a feedstock obtained from a renewable source chosen from oils and fats of plant or animal origin, or mixtures of such feedstocks, containing triglycerides and/or free fatty acids and/or esters, comprising at least:
a) a step of hydrotreating said feedstock in the presence of a catalyst in a fixed bed, said catalyst comprising a hydrogenating function and an oxide support, at a temperature of between 200 and 450° C., at a pressure of between 1 MPa and 10 MPa, at an hourly space velocity of between 0.1 h⁻¹ and 10 h⁻¹ and in the presence of a total amount of hydrogen mixed with the feedstock such that the hydrogen/feedstock ratio is between 70 and 1000 Nm³ of hydrogen/m³ of feedstock,
b) a step of separating at least a portion of the effluent obtained from step a) into at least a light fraction and at least a hydrocarbon liquid effluent,
c) a step of removing at least a portion of the water from the hydrocarbon liquid effluent obtained from step b),
d) a step of hydroconversion of at least a portion of the hydrocarbon liquid effluent obtained from step c) in the presence of a bifunctional hydroconversion catalyst in a fixed bed, said catalyst comprising a molybdenum and/or tungsten sulfide phase in combination with at least nickel and/or cobalt, said hydroconversion step being performed at a temperature of between 250° C. and 500° C., at a pressure of between 1 MPa and 10 MPa, at an hourly space velocity of between 0.1 and 10 h⁻¹ and in the presence of a total amount of hydrogen mixed with the feedstock such that the hydrogen/feedstock ratio is between 70 and 1000 Nm³/m³ of feedstock, in the presence of a total amount of sulfur such that the ratio between the partial pressure of hydrogen sulfide and of hydrogen at the inlet of said hydroconversion step is less than 5×10⁻⁵,
e) a step of fractionating the effluent obtained from step d) to obtain at least a middle distillate fraction.

2. The process as claimed in claim 1, in which, in step a), the feedstock is placed in contact with a catalyst in a fixed bed at a temperature of between 220 and 350° C., at a pressure of between 1 MPa and 6 MPa, and at an hourly space velocity of between 0.1 h⁻¹ and 10 h-1, the feedstock being placed in contact with the catalyst in the presence of hydrogen and in the presence of a total amount of hydrogen mixed with the feedstock such that the hydrogen/feedstock ratio is between 150 and 750 Nm³ of hydrogen/m³ of feedstock.

3. The process as claimed in claim 1, in which the separation step b) is performed by combining one or more high-pressure and/or low-pressure separators, and/or steps of distillation and/or of high-pressure and/or low-pressure stripping.

4. The process as claimed in claim 1, in which said step c) is performed by drying, by passage over a desiccant, by flash, by decantation or by a combination of at least two of these techniques.

5. The process as claimed in claim 1, in which step d) is performed in the presence of a total amount of sulfur such that the ratio between the partial pressure of hydrogen sulfide and of hydrogen at the inlet of said hydroconversion step is less than 4×10⁻⁵.

6. The process as claimed in claim 5, in which step d) is performed in the presence of a total amount of sulfur such that the ratio between the partial pressure of hydrogen sulfide and of hydrogen at the inlet of said hydroconversion step is less than 3×10⁻⁵.

7. The process as claimed in claim 6, in which step d) is performed in the presence of a total amount of sulfur such that the ratio between the partial pressure of hydrogen sulfide and of hydrogen at the inlet of said hydroconversion step is less than 2×10⁻⁵.

8. The process as claimed in claim 7, in which step d) is performed in the presence of a total amount of sulfur such that the ratio between the partial pressure of hydrogen sulfide and of hydrogen at the inlet of said hydroconversion step is less than 1.5×10⁻⁵.

9. The process as claimed in claim 1, in which said hydrogen stream undergoes a purification step in the case where the atomic oxygen content in said hydrogen stream at the inlet of step d) is greater than 250 ppm by volume.

10. The process as claimed in claim 1, in which said hydrogen stream undergoes a purification step in the case where the atomic oxygen content in said hydrogen stream at the inlet of step d) is greater than 50 ppm by volume.

11. The process as claimed in claim 9, in which said purification step is performed according to the methods of pressure swing adsorption (PSA) or temperature swing adsorption (TSA), amine scrubbing, methanation, preferential oxidation or membrane processes, used alone or in combination.
